(19) United States
(12) Patent Application Publication
(10) Pub. No.: US 2015/0091752 A1
(43) Pub. Date: Apr. 2, 2015

(54) SATELLITE SIGNAL SEARCHING METHOD

(71) Applicant: Seiko Epson Corporation, Tokyo (JP)

(72) Inventors: Kiyotaka MURAKI, Shiojiri (JP); Tomoyuki KURATA, Matsumoto (JP)

(21) Appl. No.: 14/482,068

(22) Filed: Sep. 10, 2014

(30) Foreign Application Priority Data
Sep. 27, 2013 (JP) 2013-201041

(51) Int. Cl. G01S 19/24

(52) U.S. Cl. CPC G01S 19/24
USPC 342/357.63

(57) ABSTRACT

A satellite signal searching method includes: determining, based on transmitted signal information in which whether satellite signals are transmitted from positioning satellites is managed for each signal type, and characteristics of the signal types, the order of searching the satellite signals.

### CROSS-REFERENCE

This application claims priority to Japanese Patent Application No. 2013-201041, filed Sep. 27, 2013, the entirety of which is hereby incorporated by reference.

### BACKGROUND

1. Technical Field

The present invention relates to a satellite signal searching method of searching a satellite signal transmitted from a positioning satellite.

2. Related Art

In recent years, positioning satellites of global navigation satellite system (GNSS) (hereinafter, referred to as “GNSS satellite”) have been launched from around the world. The GNSS satellites are represented by positioning satellites such as global positioning system (GPS) of the United States, global orbiting navigation satellite system (GLONASS) of Russia, Galileo of the European Union, COMPASS of China, and Quasi-Zenith satellite system (QZSS) of Japan, and their launching is continuously planned. The respective GNSS satellites transmit a plurality of satellite signals such as L1C/A signals and L1C signals. A receiver requires a substantial amount of time to receive the satellite signals from all of the GNSS satellites and to thus acquire positioning information. Thus, the receiver selects a necessary GNSS satellite and receives satellite signals. For example, in JP-A-2003-149315, a satellite signal is received from a GNSS satellite positioned at a high elevation angle to select the GNSS satellite based on the level of the received signal.

However, in the receiver described in JP-A-2003-149315, an unexpected time is required to capture satellite signals from the selected GNSS satellite, and thus there is a concern that the positioning performance of the receiver may be affected. Specifically, a GNSS satellite does not always transmit all of satellite signals which are transmittable as specifications of the GNSS satellite (hereinafter, the specifications are referred to as “signal transmission specifications”). For example, in some cases, a satellite launched in the past does not transmit some of satellite signals which are transmitted from a newly launched satellite, even when the foregoing satellites belong to the same GNSS. In such cases, even when satellite signals are received based on the signal transmission specifications, the satellite signals may not be received. Since a process of searching satellite signals which are not transmitted requires a large amount of time until it is determined that the satellite signals have not been transmitted, delay is caused in a position calculation process of the receiver. In addition, the power consumption of an operation circuit which is required for the searching process is wasted.

### SUMMARY

An advantage of some aspects of the invention is that it provides a satellite signal searching method in which a load on a satellite signal receiving process is suppressed.

The invention can be implemented as the following forms or application examples.

### Application Example 1

This application example is directed to a satellite signal searching method including: determining, based on transmitted signal information in which information indicating whether satellite signals are transmitted from positioning satellites is associated with signal types of the satellite signals and identification information of the positioning satellites, the order of searching the satellite signals.

According to this application example, the order of searching satellite signals is determined based on transmitted signal information. Since the order of searching satellite signals can be determined in consideration of whether a certain type of satellite signal is transmitted from a positioning satellite, a load on the searching process can be suppressed.

### Application Example 2

It is preferable that the determining further includes determining the order of searching the satellite signals based on characteristics of the signal types.

According to this application example, the order of searching satellite signals can be determined based on characteristics of the signal types. For example, by selecting characteristics of the signal types meeting the purpose of use of a receiver, the order can be determined so that satellite signals having a large effect on achieving the purpose of use are prioritized. Accordingly, a more efficient satellite signal searching method can be provided.

### Application Example 3

It is preferable that the characteristics include multipath resistance.

According to this application example, the characteristics of the signal types include multipath resistance. Therefore, for example, when the order is determined so that satellite signals having an effect on the multipath resistance are prioritized, the receiver is little influenced by multipath waves even under an environment such as a high-rise building street where multipath reflection frequently occurs. Accordingly, positioning information can be acquired with high accuracy.

### Application Example 4

It is preferable that the characteristics include power saving characteristics.

According to this application example, the characteristics of the signal types include power saving characteristics. Therefore, for example, when the order is determined so that satellite signals having an effect on the power saving are prioritized, the receiver can be used for a longer time than in a case in which the power saving characteristics are not included.

### Application Example 5

It is preferable that the satellite signal searching method according to the application example described above further includes: searching the satellite signals in the order.

According to this application example, the satellite signals can be searched in accordance with the determined order.

### Application Example 6

It is preferable that the satellite signal searching method according to the application example described above further includes: searching the satellite signals based on signal transmission specifications of the positioning satellites.

### Application Example 7

In the satellite signal searching method according to the application example described above, it is preferable that the determining includes not setting, as searching targets, the satellite signals of the signal types which are not captured in the searching for a predetermined period of time.

According to this application example, the satellite signals are searched based on signal transmission specifications of the positioning satellites. The satellite signals of the signal types which cannot be captured are not searched for a predetermined period of time. Accordingly, by not searching the satellite signals which are less likely to be transmitted for a predetermined period of time, a load on the searching process can be reduced.

### BRIEF DESCRIPTION OF THE DRAWINGS

The invention will be described with reference to the accompanying drawings, wherein like numbers reference like elements.

FIG. 1 is a block diagram showing an example of a functional configuration of a receiver.

FIG. 2 is a functional configuration diagram of a baseband processing unit.

FIG. 3A is a diagram showing an example of a satellite management table, FIG. 3B is a diagram showing an example of a signal type management table, and FIG. 3C is a diagram showing an example of a signal type characteristic table.

FIG. 4A is a diagram showing an example of a recording table, and FIG. 4B is a diagram showing an example of the recording table.

FIG. 5A is a diagram showing an example of a searching target satellite table, FIG. 5B is an image showing an example of the arrangement of visible satellites, and FIG. 5C is a diagram showing an example of a satellite signal searching order list.

FIG. 6 is a flowchart showing a flow of a baseband process.

FIG. 7 is a flowchart showing a flow of a satellite signal searching order process.

FIG. 8 is a flowchart showing a flow of a positioning information acquisition process.

### DESCRIPTION OF EXEMPLARY EMBODIMENTS

Hereinafter, embodiments of the invention will be described with reference to the drawings. However, applicable embodiments of the invention are not limited thereto.

### Configuration of Receiver

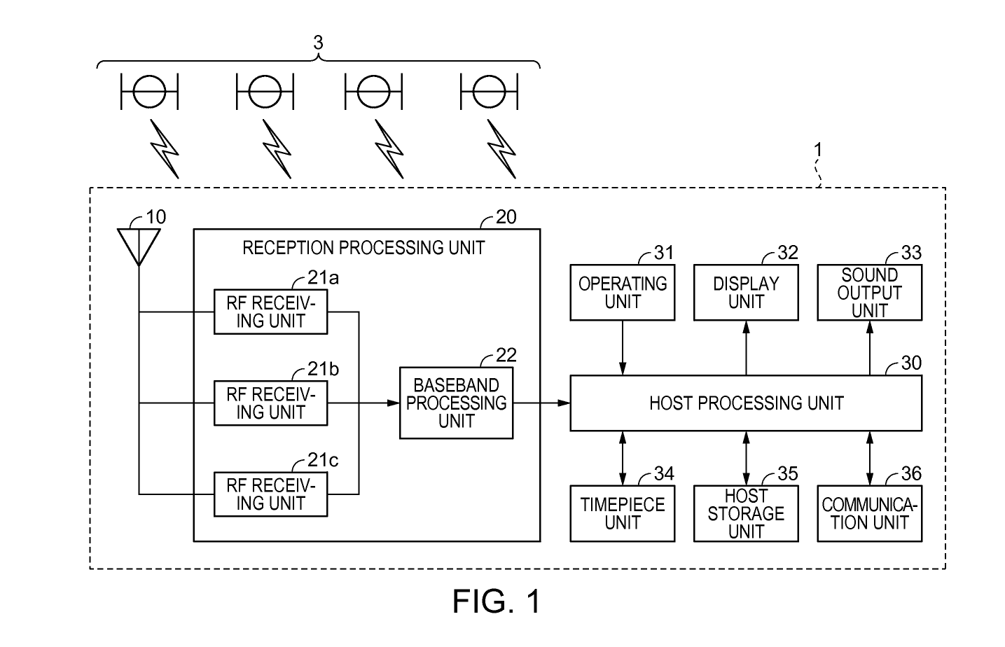

FIG. 1 is a block diagram showing an example of a functional configuration of a receiver 1 according to a first embodiment.

The receiver 1 as an example of an electronic device is a device which receives satellite signals transmitted from GNSS satellites 3, and calculates a position of the receiver 1 based on the received satellite signals. The GNSS satellite 3 transmits at least one signal type of satellite signal included in signal transmission specifications.

The receiver 1 is provided with a satellite receiving antenna 10, a reception processing unit 20, a host processing unit 30, an operating unit 31, a display unit 32, a sound output unit 33, a timepiece unit 34, a host storage unit 35, and a communication unit 36.

The satellite receiving antenna 10 is an antenna which receives radio frequency (RF) signals including satellite signals transmitted from the GNSS satellites 3, and receives signals in a plurality of frequency bands, including center frequencies set for the respective signal types of the satellite signals. The received signals are output to the reception processing unit 20.

The reception processing unit 20 is provided with RF receiving units 21a, 21b, and 21c, and a baseband processing unit 22. The reception processing unit 20 is a circuit or a device which calculates a position of the receiver 1 based on the satellite signals received by the satellite receiving antenna 10. Each of the RF receiving units 21a, 21b, and 21c and the baseband processing unit 22 can be manufactured as a separate large scale integration (LSI) or a chip.

The RF receiving units 21a, 21b, and 21c are each an RF signal receiving circuit, and receive RF signals having different frequency bands. In the following description, the RF receiving units 21a, 21b, and 21c will be collectively referred to as the RF receiving units 21.

Specifically, the RF receiving units 21 extract and receive a signal for each of peripheral frequency bands of the center frequencies set for the respective signal types of the satellite signals. As a circuit configuration, for example, a receiving circuit which converts an RF signal output from the satellite receiving antenna 10 into a digital signal using an analog to digital (AD) converter, and processes the digital signal may be configured. In addition, a configuration may be employed in which an RF signal output from the satellite receiving antenna 10 is processed in a state where the RF signal is an analog signal, and is finally A/D converted to output a digital signal to the baseband processing unit 22. Three types of the RF receiving units 21 are configured for each frequency band, but there is no limitation on the number of types. One or two types, or four or more types may be provided to be able to receive RF signals in a plurality of frequency bands.

The baseband processing unit 22 searches satellite signals of the GNSS satellites 3, which are capturing targets, from the signals input from the RF receiving units 21. When satellite signals which are capturing targets are specified, information necessary for positioning is acquired from the satellite signals. Specifically, removal of carrier waves and a correlation process are performed on the signals input from the RF receiving units 21 to search satellite signals which are capturing targets. When the input signals can be specified as satellite signals (when the satellite signals are captured), positioning information such as pseudo distance information and satellite orbit information is acquired from the captured satellite signals. These processes are performed in order by multitasking for each satellite signal type on the digital signals input from the plurality of RF receiving units 21. In addition, satellite signals which are capturing targets are searched from the plurality of GNSS satellites 3, and using positioning information acquired therefrom, a position of the receiver 1 and a timepiece error are calculated. The baseband processing unit 22 will be described later in detail.

The host processing unit 30 is a central processing unit (CPU), and integrally controls the respective units of the receiver 1 in accordance with various programs such as control programs and application programs stored in the host storage unit 35. For example, the host processing unit 30 displays, on the display unit 32 or the like, a position of position coordinates acquired for each unit time from the reception processing unit 20 together with peripheral map information in accordance with an application program or the like to indicate a moving path of the receiver 1 or the like. In addition, the host processing unit 30 inputs position information such as position coordinates calculated by the reception processing unit 20, and stores the information in the host storage unit 35 as needed.

The operating unit 31 is, for example, an input device having a touch panel, a button switch or the like, and outputs a signal of a pushed key or button to the host processing unit 30. By operating this operating unit 31, various instructions such as a current position calculation request are input in accordance with various applications.

The display unit 32 is a display device having a liquid crystal display (LCD) or the like, and performs various display processes based on display signals output from the host processing unit 30. The display unit 32 displays a position display screen, time information and the like together with map information and the like.

The sound output unit 33 is a sound output device having a speaker, a buzzer, or the like, and outputs various sounds based on sound output signals output from the host processing unit 30. Voice guidance according to the operation of the receiver 1, an alarm sound at the time of arrival at a destination, and the like are output from the sound output unit 33.

The timepiece unit 34 is an internal timepiece of the receiver 1, and has a crystal oscillator or the like including a crystal vibrator and a transmission circuit. The time of the timepiece unit 34 is output to the baseband processing unit 22 and the host processing unit 30 as needed. The time of the timepiece unit 34 is corrected based on a timepiece error calculated by the baseband processing unit 22.

The host storage unit 35 has a storage device such as a read only memory (ROM), a flash ROM, and a random access memory (RAM), and stores control programs for controlling the receiver 1 by the host processing unit 30, various application programs, and data including position information output from the host processing unit 30.

The communication unit 36 is, for example, a wireless LAN adapter, and has an internet protocol (IP) and a common communication protocol in common with an external device. The communication unit 36 is not limited to this configuration, and may be a communication adapter capable of performing wireless communication. For example, it may be a Bluetooth (registered trade name) adapter. The communication unit 36 transmits the data stored in the host storage unit 35 to a personal computer (PC) or a server on the network using the IP. In addition, the communication unit 36 receives various information related to the GNSS satellites 3, maps corresponding to position information, and the like from the PC or the server on the network. The communication unit 36 maybe configured to include a physical communication terminal and to be connected to a separate device such as a PC via a cable to transmit and receive data from the above-described PC or server through the separate device.

### Configuration of Baseband Processing Unit

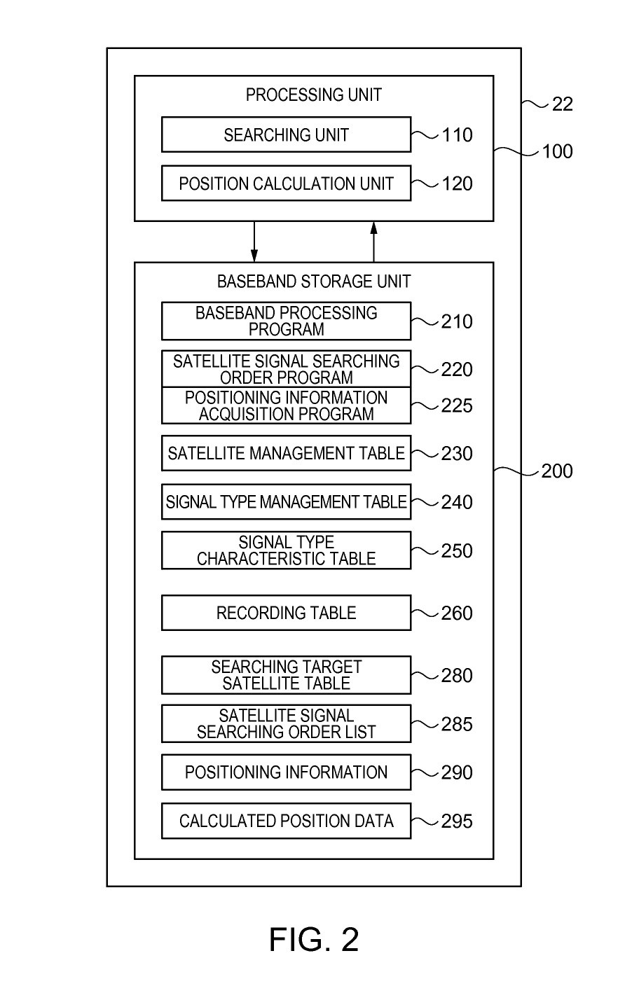

FIG. 2 is a functional configuration diagram of the baseband processing unit 22. The baseband processing unit 22 is provided with a processing unit 100, a baseband storage unit 200, and the like.

The processing unit 100 has a processor such as a CPU or a digital signal processor (DSP), and integrally controls the respective functional units of the baseband processing unit 22 based on a program, data, or the like stored in the baseband storage unit 200. The processing unit 100 is provided with a searching unit 110 and a position calculation unit 120.

The searching unit 110 is a functional unit which searches satellite signals which are capturing targets from the received signals, and acquires positioning information from the captured satellite signals. Specifically, satellite signals which are capturing targets are selected, and the order of searching the satellite signals is determined. The received signals input from the RF receiving units 21 are subjected to a known correlation process using pseudo random noise (PRN) codes of the GNSS satellites 3 which are capturing targets, and a demodulation process is performed with a demodulation system corresponding to the signal types of the satellite signals which are capturing targets to capture the satellite signals. A navigation message overlapping the captured, received signal is separated to obtain almanac information and ephemeris information as positioning information.

The positioning information also includes information of radio wave propagation delay of a cyclic pattern of the PRN code at the time of capturing. The obtained positioning information is stored as positioning information 290 in the baseband storage unit 200, and is output to the position calculation unit 120.

The position calculation unit 120 is a functional unit which calculates a position of the receiver 1. The position calculation unit 120 acquires, from the searching unit 110, positioning information 290 with respect to at least the four GNSS satellites 3 to perform a known position calculation process, thereby calculating the position (position coordinates) and a timepiece error (clock bias) of the receiver 1. The position calculation process can be realized as, for example, a process to which a least-squares method or a method using a Kalman filter or the like is applied. The calculated position information is stored as calculated position data 295 in the baseband storage unit 200.

The baseband storage unit 200 has a storage device such as a ROM, a flash ROM, and a RAM, and stores control programs for integrally controlling the baseband processing unit 22 by the processing unit 100, various programs for realizing various functions such as a satellite signal capturing function and a position calculation function, data, and the like. In addition, data related to the GNSS satellites 3 and the satellite signals which is used in the searching unit 110 and the position calculation unit 120, calculated data, and the like are stored in the form of a data table, and are updated and used every time. Specifically, a baseband processing program 210, a satellite signal searching order program 220, a positioning information acquisition program 225, a satellite management table 230, a signal type management table 240, a signal type characteristic table 250, a recording table 260, a searching target satellite table 280, a satellite signal searching order list 285, positioning information 290, calculated position data 295, and the like are stored.

The baseband processing program 210 is a program for controlling the baseband processing unit 22, and is executed by the processing unit 100 to realize the functions of the searching unit 110, the position calculation unit 120 and the like. In addition, it invokes the satellite signal searching order program 220, the positioning information acquisition program 225, and the like. The baseband processing program 210 will be described later in detail.

The satellite signal searching order program 220 is a program which is invoked by the baseband processing program 210 to determine the order of searching the satellite signals to thus output the satellite signal searching order list 285.

The positioning information acquisition program 225 is a program which is invoked from the baseband processing program 210 to search and capture satellite signals transmitted from the GNSS satellites 3. The positioning information 290 is acquired from the captured satellite signals. The positioning information 290 is stored in the baseband storage unit 200. The satellite signal searching order program 220 and the positioning information acquisition program 225 will be described later in detail.

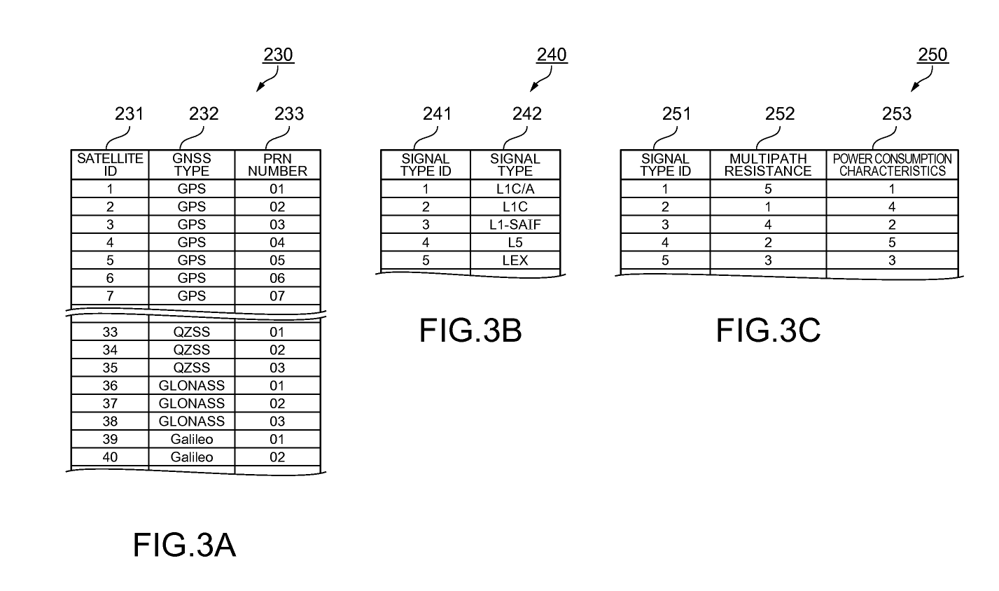

Next, the satellite management table 230, the signal type management table 240, and the signal type characteristic table 250 included in the baseband storage unit 200 will be described with reference to FIGS. 3A to 3C.

FIG. 3A is a diagram showing an example of the satellite management table 230, FIG. 3B is a diagram showing an example of the signal type management table 240, and FIG. 3C is a diagram showing an example of the signal type characteristic table 250. When use of the receiver 1 is started, initial data is stored in advance in the respective tables of the baseband storage unit 200. The data of the respective tables of the baseband storage unit 200 is updated by performing a baseband process to be described later. The data may be updated based on information acquired from a server or the like on the network via the communication unit 36.

The satellite management table 230 is a table showing the types of the GNSS satellites launched from around the world, including the GNSS satellites 3, and has items, i.e., a satellite ID 231, a GNSS type 232, and a PRN number 233.

Numbers for identifying the GNSS satellites 3 defined by the processing unit 100 are stored in the satellite ID 231. The numbers (satellite IDs) stored in the satellite ID 231 are used in common in the tables and lists of the baseband storage unit 200.

Names of the GNSSs used in many countries are stored in the form of a bit pattern or a letter string such as “GPS” and “QZSS” in the GNSS type 232.

Identification numbers (identification information) of the GNSS satellites 3 defined separately in advance as specifications for the respective pieces of data in the GNSS type 232 are stored in the PRN number 233. The identification numbers of the GNSS satellites 3 are acquired from the positioning information (almanac information). In this embodiment, since the PRN number 233 corresponds to the satellite ID 231, it can be said that the satellite ID 231 is also identification information of the GNSS satellites 3.

The signal type management table 240 is a table showing the signal types of the satellite signals, and has items, i.e., a signal type ID 241 and a signal type 242.

Numbers for identifying the signal types defined by the processing unit 100 are stored in the signal type ID 241. The numbers (signal type IDs) stored in the signal type ID 241 are used in common in the tables and lists of the baseband storage unit 200.

Names of the signal types of the satellite signals are stored in the form of a bit pattern or a letter string such as “L1C/A” and “L1C” in the signal type 242.

The signal type characteristic table 250 is a table showing, for each signal type, characteristics of the signal type, and has items, i.e., a signal type ID 251, a multipath resistance 252, and a power consumption characteristics 253.

Numerical values referring to the signal type ID 241 of the signal type management table 240 are stored in the signal type ID 251.

The multipath resistance 252 stores, for each signal type, a numerical value indicating the order of excellence in multipath-avoiding characteristics. The multipath-avoiding characteristics are an index indicating the degree of an influence of multipath waves, and are analyzed by focusing on autocorrelation characteristics varying according to modulation systems of the signal types. According to the modulation systems of the signal types, a possibility that multipath waves appearing in the vicinity of main waves of the satellite signals can be excluded is higher than other modulation systems. For example, a binary offset carrier (BOC) system employed in the case of the L1C signal provides a narrower main peak width in the autocorrelation characteristics than a binary phase shift keying (BPSK) system employed in the case of the L1C/A signal, and thus multipath waves are easily excluded. In this embodiment, “1” is stored in the multipath resistance 252 of L1C (signal type ID=2) which is excellent in multipath-avoiding characteristics. Next, “2” is stored in the case of L5 (signal type ID=4), “3” is stored in the case of LEX (signal type ID=5), “4” is stored in the case of L1-SAIF (signal type ID=3), and finally, “5” is stored in the case of L1C/A (signal type ID=1).

The power consumption characteristics 253 stores numerical values ordered in ascending order of power consumption used in the receiving and searching process of the receiver 1. The power consumption characteristics are classified by focusing on calculation amounts in the signal process varying according to the modulation systems of the signal types. For example, a L1C/A signal process in the receiver 1 can be performed for approximately one-fortieth of time spent for a L1C signal process. In this example, the power consumption is the lowest in the case of L1C/A. Next, the ordering is provided in order of L1-SAIF, LEX, L1C, and L5.

As the characteristics of the signal type characteristic table 250, the multipath resistance and the power consumption characteristics are mentioned. However, the characteristics of the signal type characteristic table 250 are not limited to these examples so long as these are characteristics which are exhibited according to the signal types. Further items can be added.

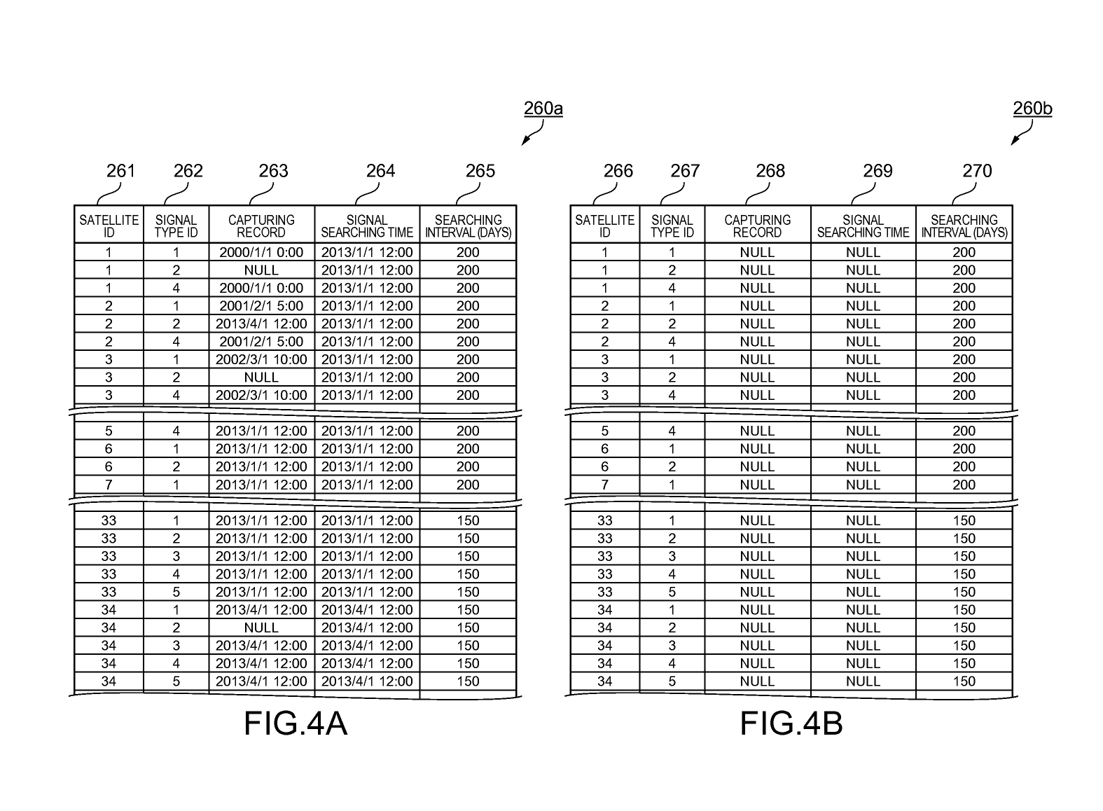

Next, the recording table 260 included in the baseband storage unit 200 will be described with reference to FIGS. 4A and 4B.

FIGS. 4A and 4B are each a diagram showing an example of the recording table 260. A recording table 260a of FIG. 4A shows a state where results of the searching of satellite signals by the receiver 1 have been recorded. A recording table 260b of FIG. 4B shows a state before the searching of satellite signals by the receiver 1. That is, the recording tables 260a and 260b show the state where the searching situation has been recorded and the state before the recording, respectively. The recording table 260a is a table in which a history of the searching of satellite signals is recorded, and has items, i.e., a satellite ID 261, a signal type ID 262, a capturing record 263, a signal searching time 264, and a searching interval (days) 265. The recording table 260b is a table before the recording of the history of the searching of satellite signals in the recording table 260a, and has a satellite ID 266, a signal type ID 267, a capturing record 268, a signal searching time 269, and a searching interval (days) 270 as the same types of items.

The recording table 260a corresponds to transmitted signal information. The recording table 260b can be said to be information including the signal transmission specifications of the GNSS satellites 3. The capturing record 263 corresponds to information indicating whether a satellite signal has been transmitted from a positioning satellite. The signal type ID 262 (267) corresponds to the signal type of the satellite signal, and the satellite ID 261 (266) corresponds to the identification information of the positioning satellite. In the recording table 260a (260b) , the satellite ID 261 (266), the signal type ID 262 (267) , and the capturing record 263 (268) are associated with each other.

In the satellite ID 261 (266) and the signal type ID 262 (267), numerical values referring to the satellite ID 231 of the satellite management table 230 and the signal type ID 241 of the signal type management table 240 are stored, respectively.

In the capturing record 263, as for recording of results in the capturing of the satellite signals shown in the satellite ID 261 (266) and the signal type ID 262 (267), an initial capturing date is stored in the form of year/month/day/hour/minute when the capturing succeeds, and “NULL” is stored when the signal is searched, but not captured, and thus the capturing fails and when there are no searching results. In the recording table 260b, since there are no results in the searching of satellite signals, the capturing record 268 stores “NULL”.

In the signal searching time 264, as for recording of times at which the satellite signals shown in the satellite ID 261 and the signal type ID 262 are searched, a searching execution time is stored in the form of year/month/day/hour/minute regardless of a result of whether the signal can be searched and captured. In the signal searching time 264, the latest time at which a target satellite signal has been searched is recorded. When there are no results in the searching process, “NULL” is recorded as shown in the signal searching time 269 of the recording table 260b.

The searching interval (days) 265 (270) stores an interval up to the execution of the next searching process, represented by a numerical value indicating the number of days. In this searching interval (days), the number of days determined for each satellite signal in advance is stored.

The data in the respective items of the recording table 260a (260b) is updated by performing the searching process. An update situation of the data in the respective items of the recording table 260a after recording from the state of the recording table 260b before the recording of the searching history will be described in chronological order.

The recording table 260b shows a state before the actual searching of satellite signals, and reflects the signal transmission specifications of the GNSS satellites 3. For example, values in the first to third lines of the satellite ID 266 are all “1”, and values in the signal type ID 267 are “1”, “2”, and “4”, respectively. This represents that a GPS satellite (satellite ID=1) having a PRN number of 01 has signal transmission specifications in which satellite signals of which the signal type names are L1C/A (signal type ID=1), L1C (signal type ID=2), and L5 (signal type ID=4), respectively, are transmitted. In addition, “NULL” is recorded in the capturing record 268 and the signal searching time 269, and this represents that the receiver 1 has no results in the process of searching these satellite signals at the time when the recording table 260b is prepared.

Next, in the recording table 260a, in the line where “1” (satellite ID=1) is recorded in the satellite ID 261 and “1” (signal type ID=1) is recorded in the signal type ID 262, “2000/1/1 0:00” is recorded in the capturing record 263 and “2013/1/1 12:00” is recorded in the signal searching time 264. This represents that the receiver 1 has captured, from the satellite having a satellite ID of 1, a L1C/A satellite signal on “2000/1/1 0:00” for the first time, and the latest searching process has been performed on “2013/1/1 12:00”. In the line where the satellite ID is 1 and the signal type ID is 2, “NULL” is recorded in the capturing record 263, “2013/1/1 12:00” is recorded in the signal searching time 264, and “200” is recorded in the searching interval (days) 265. This represents that as a result of the searching of a L1C satellite signal from the satellite having a satellite ID of 1, it has not been possible to capture the signal, and the latest searching process has been performed on “2013/1/1 12:00”. The satellite having a satellite ID of 1 transmits a L1C/A satellite signal, but is more likely to transmit no L1C satellite signal. In addition, the next time to search a L1C satellite signal is after a date obtained by adding the searching interval (days) 265 to the signal searching time 264, that is, after a date 200 days after “2013/1/1 12:00”.

In this manner, it is possible to manage information about whether the GNSS satellites 3 actually have transmitted satellite signals (or whether the transmission possibility is high or low) with respect to the signal transmission specifications. By referring to the data in the recording table 260, excluding satellite signals which are less likely to have been transmitted, satellite signals which are more likely to have been transmitted can be preferentially searched. Accordingly, positioning information 290 necessary for the positioning calculation of the receiver 1 can be acquired for a short time. In the satellite signal searching process, the satellite signal is specified by a correlation process. A large-scale calculation process is repeated until one satellite signal is determined to have not been transmitted. By referring to the data in the recording table 260, it is not necessary to waste time to perform the calculation process for such an unnecessary searching process in the conventional method, and thus positioning information 290 necessary for the positioning operation of the receiver 1 can be acquired for a shorter time than in the past . In this manner, a time required for the calculation in the searching process in the receiver 1 and the power consumption of an operation circuit are reduced.

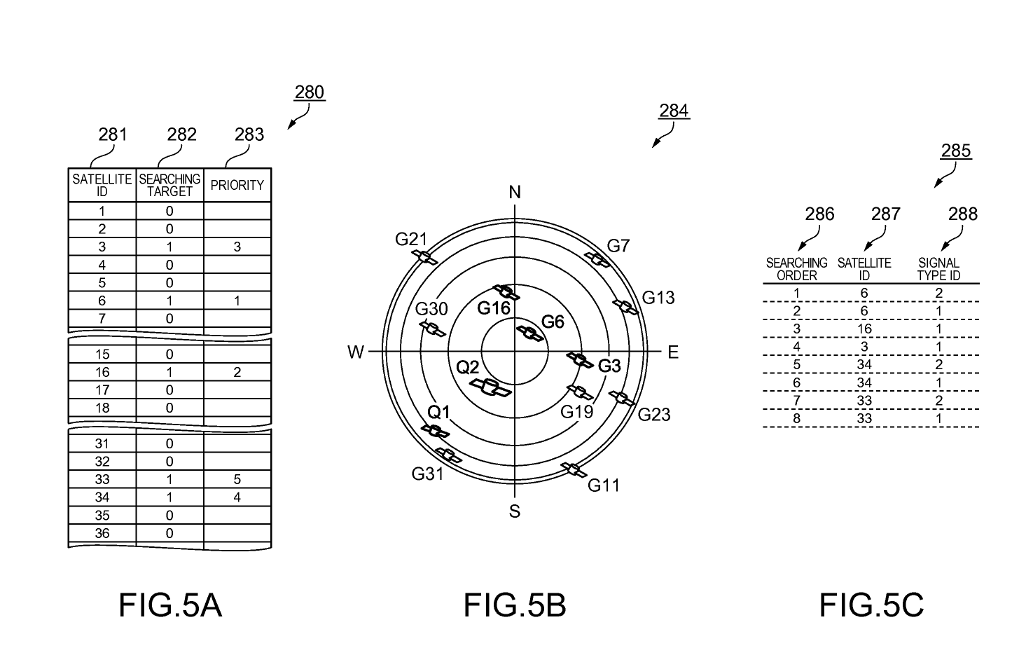

Next, the searching target satellite table 280 and the satellite signal searching order list 285 included in the baseband storage unit 200 of FIG. 2 will be described with reference to FIGS. 5A to 5C.

FIG. 5A is a diagram showing an example of the searching target satellite table 280, FIG. 5B is an image showing an example of the arrangement of visible satellites, and FIG. 5C is a diagram showing an example of the satellite signal searching order list 285.

The searching target satellite table 280 shown in FIG. 5A is a table showing: candidate GNSS satellites 3 which acquire positioning information 290; and priorities of searching of the candidates, and has items, i.e., a satellite ID 281, a searching target 282, and a priority 283.

The satellite ID 281 stores numerical values referring to the satellite ID 231 of the satellite management table 230 (FIG. 3A).

The searching target 282 shows whether the satellite of the satellite ID 281 is a searching target. “1” is stored when the satellite is a target, and “0” is stored when the satellite is not a target.

The priority 283 stores numerical values indicating the order of searching the GNSS satellites 3 which are searching targets.

When there is information related to an initial position of the receiver 1 (an approximate position when the positioning is started) and a time, a visible satellite above the initial position is determined, and in the searching target 282, “1” is stored with respect to the visible satellite. When there is no information related to the initial position and the time, a visible satellite is determined based on a predetermined satellite list and “1” is stored in the searching target 282. The ordering in the priority 283 may be provided in descending order of elevation angle based on the position of the receiver 1, on the basis of the satellite orbit information (ephemeris or almanac) of the GNSS satellites 3.

A visible satellite image 284 shown in FIG. 5B shows an example of the arrangement of visible satellites when the order stored in the priority 283 of the searching target satellite table 280 is generated. The visible satellite image 284 shows the position of the receiver 1 as a central point of a circle (an intersection between the N-S line and the E-W line). Regarding the GNSS satellites 3 arranged in the sky, GPS satellites are denoted by the numerical values in the PRN number 233 (FIG. 3A) following the letter “G”, and QZSS satellites are denoted by the numerical values in the PRN number 233 following the letter “Q”. “E”, “W”, “S”, and “N” represent eastward, westward, southward, and northward directions, respectively. The visible satellite image 284 shows the fact that the closer to the center of the circle, the greater the elevation angles of the GNSS satellites 3 with respect to the receiver 1, and the farther from the center of the circle, the less the elevation angles. It is found that GPS satellites G6 (satellite ID=6), G16 (satellite ID=16), and G3 (satellite ID=3) and QZSS satellites Q2 (satellite ID=34) and Q1 (satellite ID=33) are arranged in descending order of elevation angle. In the priority 283 of the searching target satellite table 280, the ordering is provided in descending order of elevation angle.

The satellite signal searching order list 285 shown in FIG. 5C is a list in which contents of a searching order 286, a satellite ID 287, and a signal type ID 288 are arranged line by line in the order of searching the satellite signal. For example, the list is configured as a text file.

The searching order 286 stores numerical values indicating the order of searching the satellite signals. In this example, “1” is recorded in the first line, and the sequential numbers are recorded in the subsequent lines. The numerical values (sequential numbers) stored in the searching order 286 correspond to the order of searching the satellite signals.

The satellite ID 287 and the signal type ID 288 are the numbers defined in the satellite management table 230 (FIG. 3A) and the signal type management table 240 (FIG. 3B).

In the satellite signal searching order list 285, the satellite signals recorded as “NULL” in the capturing record 263 are excluded (not recorded in the satellite signal searching order list 285) with reference to the searching target satellite table 280, the signal type characteristic table 250, and the recording table 260. Furthermore, the order of searching the satellite signals is determined in accordance with the order stored in the characteristics (multipath resistance 252 or power consumption characteristics 253) of the signal types meeting the purpose of use of the receiver 1 shown in the signal type characteristic table 250 (FIG. 3C), and is ordered and recorded in the searching order 286. In accordance with the order in the searching order 286 of the satellite signal searching order list 285, the satellite ID 287 and the signal type ID 288 are selected and the satellite signal searching process is executed, and thus a load on the searching process can be reduced. That is, since satellite signals which are more likely to be captured can be preferentially searched, it is possible to suppress the generation of a wasteful correlation operation. In addition, in this embodiment, since the searching order 286 is set with the characteristics of the signal types, satellite signals meeting the purpose of use can be more efficiently captured. The searching order 286 may be determined without referring to the characteristics of the signal types.

### Baseband Process

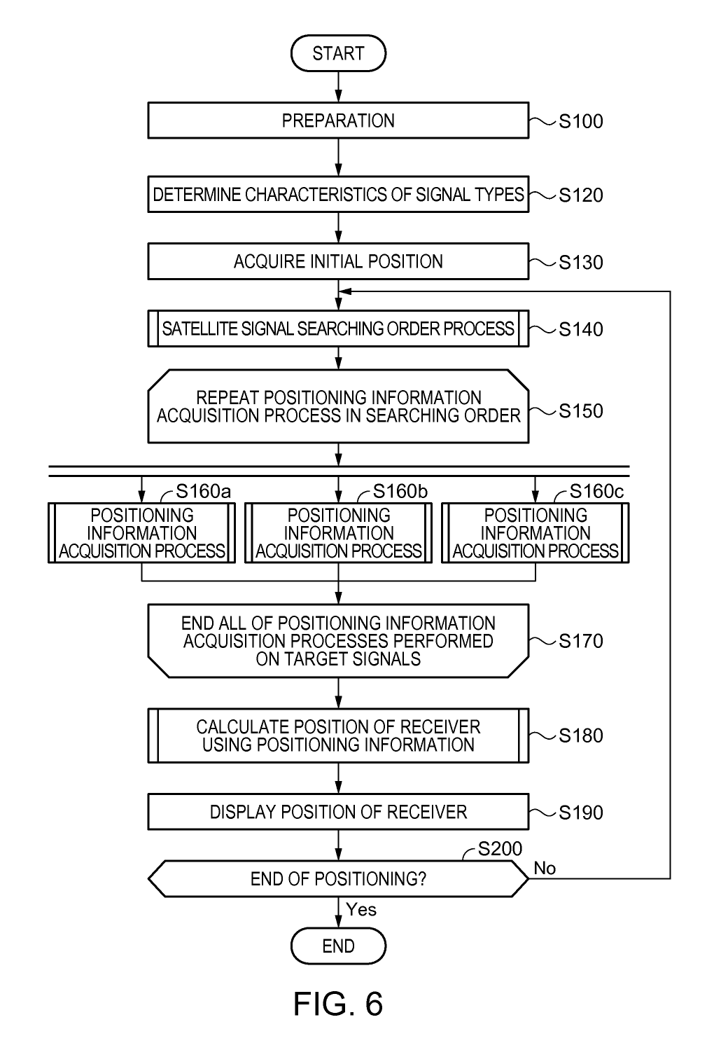

FIG. 6 is a flowchart showing a flow of a baseband process. Hereinafter, a description will be given focusing on FIG. 6 with appropriate reference to the drawings. The following flow is executed so that the processing unit 100 controls the respective units of the baseband processing unit 22 based on the baseband processing program 210 of the baseband storage unit 200 (FIG. 2).

By executing the baseband processing program 210, the satellite signal searching order program 220, the positioning information acquisition program 225, or the like is appropriately invoked to realize the respective functions including the searching unit 110 and the position calculation unit 120.

In Step S100, preparations for executing the baseband processing program 210 are made. Specifically, the respective items and data in the tables such as the satellite management table 230, the signal type management table 240, the signal type characteristic table 250, and the like to be referred to in the subsequent steps are taken in as local variables and common variables which are used in the baseband processing program 210.

In Step S120, characteristics of the signal types are determined. Specifically, a characteristic item to be used is selected from the signal type characteristic table 250 (FIG. 3C). In greater detail, when the multipath-avoiding characteristics are considered to be important, a numerical value indicating an order from the items of the multipath resistance 252 and a numerical value in the corresponding signal type ID 251 are associated with each other so as to be read into a local variable. When the power consumption characteristics are considered to be important, the items of the power consumption characteristics 253 is selected, and the numerical value of the order and the corresponding signal type ID 251 are associated with each other so as to be read into a local variable.

In Step S130, an initial position of the receiver 1 is acquired. Specifically, the position of the receiver 1 or the like calculated by the previous positioning process is acquired as an initial position. The information of the initial position is used to narrow down satellites to be searching targets (hereinafter, referred to as “target satellite”) in a satellite signal searching order process (Step S140) to be performed next. When the information of the initial position does not exist, the process proceeds to the next Step S140 without the initial position.

In Step S140, a subroutine program for determining the satellite signal searching order is executed. The subroutine program is the satellite signal searching order program 220 stored in the baseband storage unit 200, and determines the order of searching target satellite signals (hereinafter, referred to as “target signal”) to output the satellite signal searching order list 285 (FIG. 5C). The flow of the satellite signal searching order program 220 will be described later.

In Step S150, preparations for repeating a positioning information acquisition process in accordance with the searching order are made. Specifically, the values in the satellite ID 287 and the signal type ID 288 specifying the target signals are selected in accordance with the order in the searching order 286 of the satellite signal searching order list 285 (FIG. 5C). The selected values in the satellite ID 287 and the signal type ID 288 are given to the processes of Steps S160a, S106b, and S160c related to the positioning information acquisition process.

In Steps S160a, S106b, and S160c, positioning information 290 is acquired from the target signals. The three Steps S160a, S106b, and S160c are executed by the processing unit 100 based on the positioning information acquisition program 225 of the baseband storage unit 200. First, in Step S160a, positioning information 290 is acquired from the target signal indicated by the satellite ID 287 and the signal type ID 288 in aline where an order of the searching order 286 given from Step S150 is “1”. Without waiting the end of the execution, in Step S160b, positioning information 290 is acquired from the target signal indicated by the satellite ID 287 and the signal type ID 288 in a line where an order of the searching order 286 given from Step S150 is “2”. A similar process is successively performed in Step S160c. In this manner, the satellite signals given from Step S150 are subjected to the positioning information acquisition process in parallel without waiting the end of the positioning information acquisition process executed at a previous time. The processes which are performed in parallel may be realized by employing a pseudo multitasking structure by the processing unit 100, or by mounting a plurality of CPUs or DSPs on the processing unit 100 for process division. The number of the processes which are performed in parallel is not limited to three, but may be four or more. For example, 16 or 32 processes can be performed in parallel by mounting a CPU or a DSP having a high processing speed and by increasing the capacity of the internal memory. Hereinafter, Steps S160a, S160b, and S160c will be collectively referred to as Step S160.

The positioning information acquisition process in Step S160 also includes a satellite signal searching process in addition to the above-described process of acquiring the positioning information 290 from the target signals. This will be described later as a flow of the positioning information acquisition program 225.

In Step S170, it is determined whether all of the positioning information acquisition processes performed on the target signals have been ended. Specifically, until all of the positioning information acquisition processes performed on the target signals registered in the satellite signal searching order list 285 in Step S160 are ended, the process returns to Step S150 and Step S160 is repeatedly performed on the next target signal. When all of the processes are ended, the process proceeds to the next Step S180. A configuration may also be employed in which Step S160 is ended at the time when the positioning information 290 of which the number corresponds to the necessary number of satellites for the positioning or the like can be acquired. The positioning time and the power consumption can be further reduced.

In Step S180, a subroutine program is executed to calculate the position of the receiver 1 using the positioning information 290, thereby calculating the position of the receiver 1. Specifically, the position of the receiver 1 is calculated by performing a known positioning operation using at least four of ephemeris information included in a navigation message of the target signal and a pseudo distance calculated from a radio wave propagation delay time of the satellite signal.

In Step S190, for example, the position information of the receiver 1 is displayed together with map information and the like on the display unit 32.

In Step S200, whether to end the positioning is determined. When the positioning is ended (Step S200: Yes), the baseband processing program 210 is ended. When the positioning is not ended (Step S200: No), the calculated position is set as an initial position of the receiver 1 and the process returns to Step S140 to continuously perform the next positioning process.

### Satellite Signal Searching Order Program

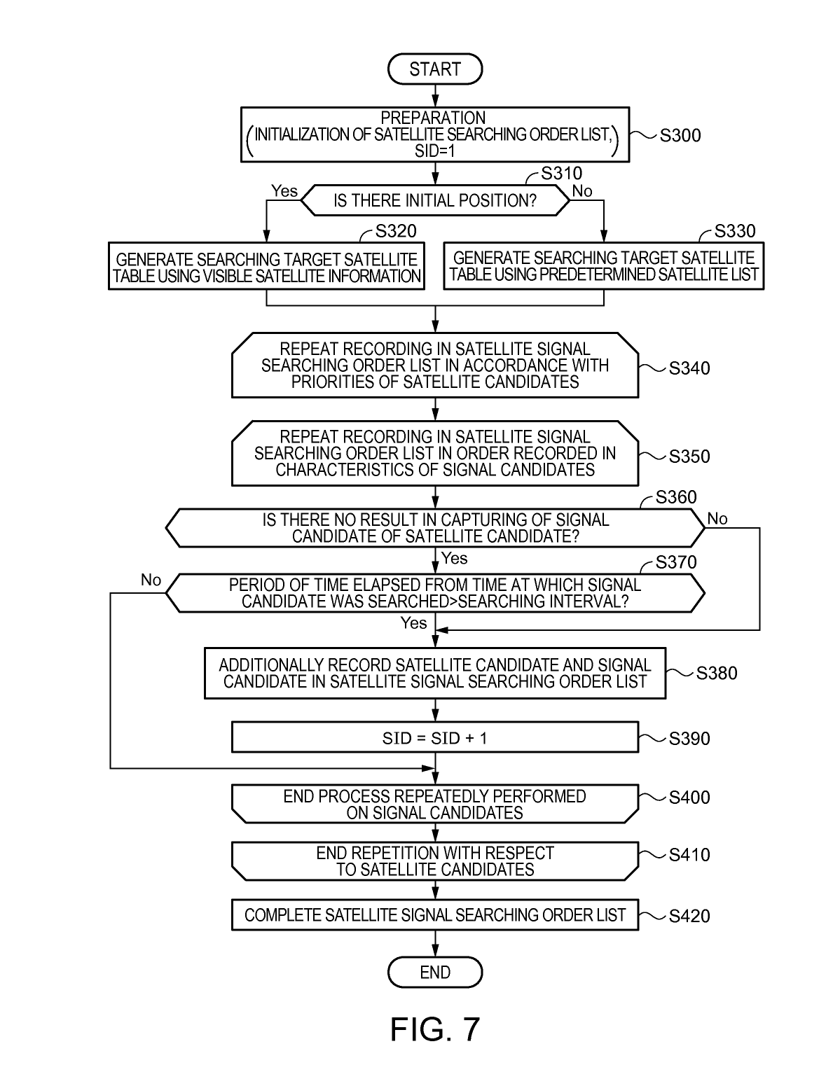

FIG. 7 is a flowchart showing a flow of the satellite signal searching order process. Hereinafter, a description will be given focusing on FIG. 7 with appropriate reference to the drawings. The satellite signal searching order process is executed by the processing unit 100 based on the satellite signal searching order program 220 of the baseband storage unit 200.

In addition, the satellite signal searching order program 220 is a subroutine program which is invoked as the satellite signal searching order process of Step S140 in the flow (FIG. 6) of the baseband processing program 210 to select the target satellites and the target signals and to determine the order of searching the target signals to thus output the satellite signal searching order list 285.

In Step S300, preparations for executing the satellite signal searching order program 220 are made. Specifically, a new empty file for storing the satellite signal searching order list 285 (FIG. 5C) in the baseband storage unit 200 is made. There is no data in the respective items, i.e., the searching order 286, the satellite ID 287, and the signal type ID 288. SID is defined as a local variable indicating the searching order to be used in the satellite signal searching order process, and “1” is input as a value thereof (SID=1). All of values of the items in the searching target 282 of the searching target satellite table 280 (FIG. 5A) are set to “0”, and all the data in the priority 283 is deleted (empty).

In Step S310, it is determined whether there is an initial position of the receiver 1. Specifically, when the initial position can be acquired in Step S130 (FIG. 6) of the baseband processing program 210 (Step S310: Yes), the process proceeds to Step S320. When the initial position cannot be acquired (Step S310: No), the process proceeds to Step S330.

In Step S320, the searching target satellite table 280 (FIG. 5A) is generated using visible satellite information. Specifically, a visible satellite is specified based on the initial position of the receiver 1 and acquired satellite orbit information (almanac information and ephemeris information). As the satellite orbit information, the information included in the positioning information 290 acquired in the past or the information acquired from a server or the like via the communication unit 36 can be used. When the visible satellite is specified, the satellite ID of the visible satellite is searched from the items of the satellite ID 281 of the searching target satellite table 280, and “1” which means that the visible satellite is a searching target is set in the items of the searching target 282 in the same line. The satellites set to “1” are candidates of the target satellites (hereinafter, referred to as the satellite candidate). In addition, the satellite orbit information of the satellite candidates is examined to determine priorities of searching of the satellite candidates. Based on information such as a positional relationship between the initial position of the receiver 1 and the position of the satellite candidate, and the reliability of the GNSS satellites 3, the priorities of searching of the satellite candidates are determined with reference to the order set in advance. For example, satellites positioned at a high elevation angle may be prioritized, or GNSS satellites 3 launched from the countries around the region where the receiver 1 is used may be prioritized. When the searching priorities are determined, the order thereof (numerical values) is stored in the items of the priority 283.

In Step S330, the searching target satellite table 280 is generated using a predetermined satellite list. Specifically, since there is no initial position of the receiver 1, the searching target satellite table 280 is generated based on a predetermined satellite list prepared in advance. The predetermined satellite list is, for example, a list of GNSS satellite orbits by which predetermined satellites can be calculated from country information of the region where the receiver 1 is used, the current time, and the like. The list is stored in advance in the ROM or the like of the baseband storage unit 200 so that the list can be used from the start of use of the receiver 1.

In Step S340, preparations for repeating the recording in the satellite signal searching order list 285 in accordance with the priorities of the satellite candidates are made. Specifically, a satellite ID in the satellite ID 281 is selected in accordance with the order shown in the priority 283 with reference to the searching target satellite table 280 (FIG. 5A). The selected satellite ID in the satellite ID 281 is given to Step S350 to execute the steps up to Step S410. Steps S350 to S410 are repeated with respect to the satellite IDs selected in order.

For example, in the example shown in the data of the searching target satellite table 280, the initially selected satellite ID 281 is “6”, and the satellite ID 6 is given to Step S350 to execute the steps up to Step S410. Steps S350 to S410 are repeated in order of the satellite IDs 16, 3, 34, and 33.

In Step S350, preparations for repeating the recording in the satellite signal searching order list 285 in order recorded in the characteristics of the candidates of the target signals (hereinafter, referred to as the signal candidate) are made. Specifically, a line of the satellite ID 261 matching the satellite ID given from Step S340 is selected with reference to the recording table 260a (FIG. 4A). The satellite signal having the signal type ID which exists in the selected line of the satellite ID 261 is a signal candidate. When the number of selected lines in the satellite ID 261 is more than one, a plurality of signal type IDs exists in the items of the signal type ID 262. The plurality of signal type IDs is selected in order of numerical value shown in the characteristic item (multipath resistance 252 or power consumption characteristics 253) of the signal type characteristic table 250 (FIG. 3C). The selected signal type ID is given to Step S360 to execute the steps up to Step S400. Steps S360 to S400 are repeated with respect to the signal type IDs selected in order.

For example, when the satellite ID given from Step S340 is 6, two lines where as signal type IDs corresponding to the satellite ID 6, “1” and “2” are recorded in the signal type ID 262, respectively, exist in the recording table 260a. Regarding the signal type IDs “1” and “2”, 1 in the signal type ID 251 corresponds to 5 in the multipath resistance 252, and 2 in the signal type ID 251 corresponds to 1 in the multipath resistance 252 in terms of the order in the multipath resistance 252 of the signal type characteristic table 250. The order of the signal type IDs “1” and “2” is shuffled and these are selected in order of “2” and “1”. That is, the initially selected signal type ID is “2”, and the signal type ID is given first to Step S360 to execute the steps up to Step S400. Next, the signal type ID “1” is selected and the steps are repeatedly executed up to Step S400. In the following description, a satellite ID selected in Step S340 is a satellite candidate, and a signal type ID selected in Step S350 is a signal candidate.

In Step S360, the presence or absence of the result in capturing of the signal candidate of the satellite candidate is determined. Specifically, the items of the capturing record 263 in a line corresponding to the signal candidate of the satellite candidate is confirmed with reference to the recording table 260a, and when the content therein is “NULL” and there is no capturing result (Step S360: Yes), the process proceeds to Step S370. When year/month/day/hour/minute is recorded, it is determined that there is a capturing result (Step S360: No) and the process proceeds to Step S380. In Step S380, since there is a result in capturing of a signal which is a signal candidate from the satellite candidate, the satellite candidate and the signal candidate are additionally recorded as a target satellite and as a target signal, respectively, in the satellite signal searching order list 285. When there is no capturing result, the process proceeds to Step S370 to determine whether to perform additional recording in the satellite signal searching order list 285.

In Step S370, it is determined whether a period of time elapsed from the time at which the signal candidate selected in Step S350 was searched in the past exceeds a searching interval. Specifically, a difference between the content of the signal searching time 264 in a line corresponding to the signal candidate of the satellite candidate and the current time is compared with the number of days in the searching interval (days) 265 in the same line with reference to the recording table 260a. When the comparison result exceeds the number of days in the searching interval (days) 265 (Step S370: Yes), the process proceeds to Step S380 for additional recording in the satellite signal searching order list 285. When the comparison result is equal to or less than the number of days in the searching interval (days) 265 (Step S370: No), the process proceeds to Step S400 without additional recording of the signal candidate in the satellite signal searching order list 285. In this manner, a satellite signal which has not been captured in the past searching can be made to be not searched again for a predetermined period of time. By virtue of this determination process, the receiver 1 is controlled so as not to frequently perform the searching process of a satellite signal which has not been transmitted.

In Step S380, the satellite candidate and the signal candidate are additionally recorded in the satellite signal searching order list 285. Specifically, a SID value, a value (satellite candidate) of the selected satellite ID, and a value (signal candidate) of the selected signal type ID are additionally recorded in one line as the searching order 286, the satellite ID 287, and the signal type ID 288 of the satellite signal searching order list 285. Then, the additionally recorded satellite candidate is dealt with as a target satellite, and the additionally recorded signal candidate is dealt with as a target signal. After the additional recording, the process proceeds to Step S390.

In Step S390, 1 is added to the SID to be the number of the searching order. Since the current SID is additionally recorded in the satellite signal searching order list 285, the next number of the searching order is prepared.

In Step S400, it is determined whether the process has been repeatedly performed on all of the signal candidates of the satellite candidates. Specifically, when all of the signal type IDs are applied to the signal type ID selected in Step S350 and Steps S350 to S390 are repeated, the process proceeds to Step S410. When unprocessed signal type IDs remain, the process returns to Step S350 and the next signal type ID is regarded as a signal candidate to repeat Steps S350 to S390.

In Step S410, it is determined whether the process has been repeatedly performed on all of the satellite candidates. Specifically, when all of the satellite IDs are applied to the satellite ID selected in Step S340 and Steps S340 to S400 are repeated, the process proceeds to Step S430. When unprocessed satellite IDs remain, the process returns to Step S340 and the next satellite ID is regarded as a signal candidate to repeat Steps S340 to S400.

In Step S420, the satellite signal searching order list 285 is completed. Specifically, all of the target satellites and all of the target signals are registered in the satellite signal searching order list 285 in which the additional recording has been performed line by line in Step S380, and the file is closed.

In this manner, the satellite signal searching order list 285 is prepared. As a result of Steps S360 and S370, a satellite signal which has not been transmitted from the GNSS satellite 3 is not additionally recorded in the satellite signal searching order list 285. In addition, a satellite signal list is prepared in the order reflecting the priorities of the GNSS satellites 3 and the order based on the characteristics of the signal types through Steps S340 and S350. By searching the satellite signals in accordance with the order in the prepared satellite signal searching order list 285, a process of searching a satellite signal which has not been transmitted from the GNSS satellite 3 can be excluded. In addition, by selecting characteristics of the signal types and by searching the satellite signals in order of excellence in the characteristics, the purpose of use can be achieved with a minimum satellite signal searching process, and the processing time which is spent for the searching process and the power consumption can be reduced.

### Positioning Information Acquisition Program

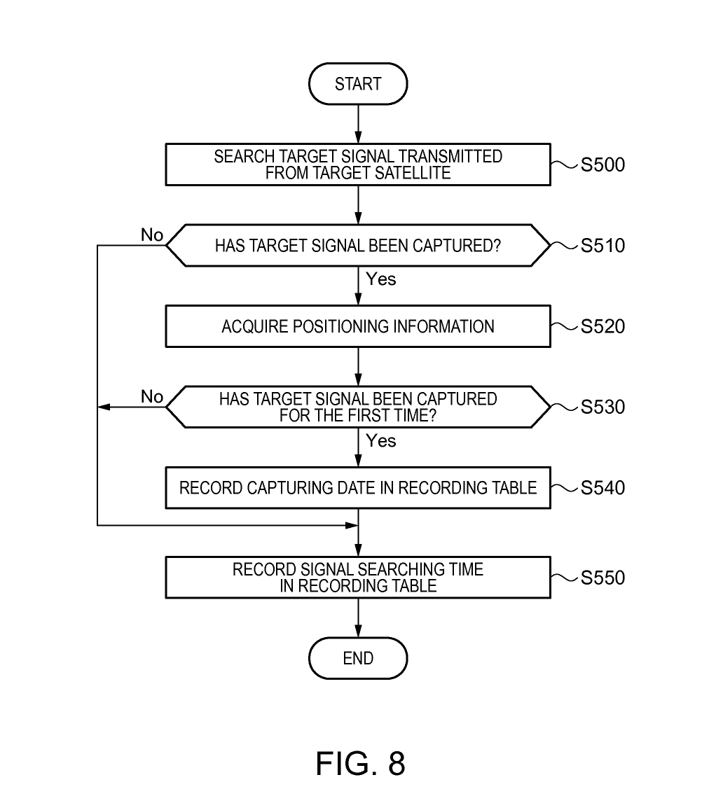

FIG. 8 is a flowchart showing a flow of the positioning information acquisition process. Hereinafter, a description will be given focusing on FIG. 8 with appropriate reference to the drawings. The following flow is executed by the processing unit 100 based on the positioning information acquisition program 225 of the baseband storage unit 200.

In addition, the positioning information acquisition program 225 is a subroutine program which is invoked as the positioning information acquisition process of Step S160 in the flow (FIG. 6) of the baseband processing program 210. The positioning information 290 is acquired from the satellite signals of the satellite IDs and the signal type IDs recorded in the satellite signal searching order list 285.

In Step S500, a target signal transmitted from a target satellite is searched. Specifically, the GNSS satellites 3 synthesize PRN codes corresponding to PRN numbers for identifying the satellites into a navigation message, and transmit satellite signals modulated using the modulation systems according to the systems of the respective signal types. In the searching process, it is confirmed whether there is a satellite signal having the same modulation system and the same PRN code as the target signal among a plurality of satellite signals which are transmitted at the same time. Specifically, detailed information necessary for capturing the target signal, such as the center frequency of the carrier wave of the target signal, the PRN number, and the modulation method, is acquired from information of the GNSS type, the PRN number, and the signal type corresponding to the satellite ID 231 (FIG. 3A) and the signal type ID 241 (FIG. 3B). The detailed information is stored as accompanying information (not shown) of the satellite management table 230 and the signal type management table 240 in the baseband storage unit 200. When a demodulation process or an autocorrelation process by the PRN code is performed using the accompanying information of the target signal and a correlation peak can be confirmed by the same PRN code as the target signal, the capturing of the target signal succeeds. When a predetermined correlation process is performed, the process proceeds to Step S510. The searching with reference to the satellite signal searching order list 285 corresponds to the searching of the satellite signal based on the signal transmission specifications.

In Step S510, it is determined whether the target signal can be captured. In Step S500, when the target signal transmitted from the target satellite can be captured (Step S510: Yes), the process proceeds to Step S520, and when the target signal cannot be captured (Step S510: No), the process proceeds to Step S550.

In Step S520, the positioning information 290 is acquired. Specifically, the navigation message is separated from the target signal captured in Step S500. In addition, the positioning information 290 including information of radio wave propagation delay of a cyclic pattern of the PRN code overlapping the target signal is acquired.

In Step S530, it is determined whether the target signal has been captured for the first time. Specifically, from the recording table 260a (FIG. 4A), the content in the capturing record 263 in the line of the satellite ID 261 and the signal type ID 262 corresponding to the target satellite and the target signal is acquired. When there is “NULL” in the capturing record 263, the target signal is regarded to have been captured for the first time (Step S530: Yes), and the process proceeds to Step S540. When a date is recorded in the capturing record 263, the target signal is not regarded to have been captured for the first time (Step S530: No), and the process proceeds to Step S550.

In Step S540, a capturing date is recorded in the recording table 260. Specifically, the current year/month/day/hour/minute is recorded in the capturing record 263 of the recording table 260a. The state in which the date is recorded in the capturing record 263 indicates that there is a result of the capturing of the target signal. When the capturing date is recorded, the process proceeds to Step S550.

In Step S550, the signal searching time 264 is recorded in the recording table 260. Specifically, the current year/month/day/hour/minute is recorded in the signal searching time 264 of the recording table 260a. This signal searching time 264 is recorded regardless of whether the target signal can be captured. That is, the signal searching time 264 is a record of the execution of the process of searching the target signal, and is a time at which whether the target signal can be captured has been confirmed. When the signal searching time is recorded, the positioning information acquisition process (Step S160) is ended, and the process proceeds to Step S170 of FIG. 6.

In this manner, the positioning information 290 of the satellite signal transmitted from the target satellite can be acquired, and by updating the capturing record 263 and the signal searching time 264 of the recording table 260 during the same process, the presence or absence of the satellite signal which is less likely to be transmitted from the GNSS satellite 3 can be managed. The preparation or updating of the recording table 260 corresponds to the storing of the transmitted signal information.

As described above, according to the receiver 1 of this embodiment, the following effects can be obtained.

According to the receiver 1, the signal transmission specifications of the GNSS satellites 3 and the information of whether satellite signals are actually transmitted from the GNSS satellites 3 are managed by being recorded and updated in the recording table 260. In addition, the satellite signal searching order list 285 is prepared with reference to the recording table 260. By performing the searching process in accordance with the prepared satellite signal searching order list 285, a waste of time and power consumption which are spent for the searching of satellite signals which have not been transmitted is eliminated, and thus the searching time and the power consumption can be reduced.

In addition, according to the receiver 1, the signal types are evaluated in terms of predetermined characteristics, and the signal type characteristic table 250 in which the superiority thereof is ordered is prepared. The order of searching the satellite signals is determined with reference to the order of the superiority, and the satellite signal searching order list 285 is prepared. By performing the searching process in accordance with the prepared satellite signal searching order list 285, the satellite signals can be searched in such an order that a large effect can be expected with respect to the purpose of the positioning or the requested result. Appropriate characteristics of the signal types for achieving the purpose of use of the receiver 1 are selected to search the satellite signals in the determined order, and thus the purpose can be efficiently achieved with a minimum searching process.

Accordingly, it is possible to provide an efficient method of using a satellite signal in which the satellite signal searching process is reduced and a load on the searching process is suppressed.

### MODIFICATION EXAMPLES

Applicable embodiments of the invention are not limited to the above-described embodiment, and appropriate changes can be made without departing from the gist of the invention. Hereinafter, modification examples of the invention will be described. The same configurations as in the embodiment will be denoted by the same reference numerals, and detailed descriptions thereof will be omitted.

### Modification Example 1

A description will be given using FIG. 7. In the above-described embodiment, when there is no initial position in Step S310, the process proceeds to Step S330 to generate the predetermined searching target satellite table 280, but is not limited to this process. When there is no initial position, a specific signal type may be designated and the searching process may be performed to calculate the initial position of the receiver 1 based on the result of the searching process.

As for the specific signal type, for example, a signal type such as a L1C/A signal which is searched in a relatively short time is preferably designated. According to this process, since the satellite signals of the GNSS satellites 3 can be captured in a relatively short time, the initial position of the receiver 1 can be calculated. When the initial position is calculated, the process proceeds to Step S320 using this initial position. Accordingly, even when there is no initial position of the receiver 1 at the beginning, the initial position can be acquired in a relatively short time, and thus a time which is required for the searching process can be reduced.

### Modification Example 2

A description will be given using FIGS. 3A to 3C. In the above-described embodiment and modification example, the multipath resistance and the power consumption characteristics have been exemplified as the characteristics of the signal types, but the signal type characteristic table 250 may include reliability characteristics, noise resistance, robustness, and the like as the characteristics of the signal types. In addition, the order may be determined by combining a plurality of characteristics. By increasing a variation in the characteristics of the signal types, a possibility that an appropriate positioning result for various purposes of use and use scenes of the receiver 1 can be more rapidly acquired is increased.

### Modification Example 3

A description will be given using FIG. 2. In the above-described embodiment and modification examples, a configuration has been described in which the baseband storage unit 200 of the receiver 1 is provided with the satellite management table 230, the signal type management table 240, the signal type characteristic table 250, and the recording table 260. However, a configuration may also be employed in which at least one of the tables is prepared and recorded in a PC or a server on the network. The receiver 1 transmits the information acquired by the receiver 1 to the PC or the server via the communication unit 36 (FIG. 1). The acquired information is, for example, the initial position of the receiver 1, or the capturing record 263, the signal searching time 264 or the like recorded in the recording table 260. In the PC or the server receiving the information, the information is accumulated in a database table or the like which is managed by a database engine or the like, and an appropriate order of searching the satellite signals for the receiver 1 is calculated. The order of searching the satellite signals is transmitted to the receiver 1 from the PC or the server. In the receiver 1, the process of searching the satellite signals is performed in accordance with the received order of searching the satellite signals.

With such a configuration, the time which is required for the searching process can be reduced. Furthermore, the capacity of the internal memory which stores the tables provided in the receiver 1 can be reduced, and the power which is spent to perform the process of calculating the searching order and to maintain the internal memory can also be reduced.

### Modification Example 4

A description will be given using FIG. 6. The invention is not limited to the configurations of the above-described embodiment and modifications. The process of determining the characteristics of the signal types in Step S120 may be performed using external environment change information about the position of the receiver 1.

Specifically, the moving direction of the receiver 1 is predicted from the position information of the receiver 1 calculated in Step S180, and external environment information in the moving direction is acquired using map information. The characteristics of the signal types are determined using the external environment information.

The external environment information includes, for example, information causing a change in the signal reception situation of the GNSS satellites 3, such as forest areas, mountainous areas, residential streets, mid-rise building streets, high-rise building streets, indoors, and on the sea, and is stored together with map information in the host storage unit 35 (FIG. 1) in the receiver 1. For example, when the receiver 1 is moved from a residential street to a high-rise building street, the multipath resistance is set as characteristics to be referred to. Accordingly, in the high-rise building street, the receiver 1 can perform position calculation with high accuracy in which the influence of multipath waves is suppressed.

By switching the characteristics of the signal types according to the external environment information of the receiver 1, a user of the receiver 1 can perform searching by switching to appropriate GNSS satellites 3 and satellite signals thereof for the external environment without consciousness. Accordingly, in the receiver 1, positioning information 290 adapted to various environments can be acquired, and a possibility of position calculation application precisely reflecting various characteristics of the signal types is increased.

When position information is calculated under an indoor environment, a configuration may be employed in which a satellite to be a searching target of the GNSS satellite 3 includes an indoor positioning system such as an indoor messaging system (IMES).

What is claimed is:

1. A satellite signal searching method comprising:
determining, based on transmitted signal information in which information indicating whether satellite signals are transmitted from positioning satellites is associated with signal types of the satellite signals and identification information of the positioning satellites, the order of searching the satellite signals.

2. The satellite signal searching method according to claim 1,
wherein the determining further includes determining the order of searching the satellite signals based on characteristics of the signal types.

3. The satellite signal searching method according to claim 2,
wherein the characteristics include multipath resistance.

4. The satellite signal searching method according to claim 2,
wherein the characteristics include power saving characteristics.

5. The satellite signal searching method according to claim 1, further comprising:
searching the satellite signals in the order.

6. The satellite signal searching method according to claim 1, further comprising:
searching the satellite signals based on signal transmission specifications of the positioning satellites.

7. The satellite signal searching method according to claim 6,
wherein the determining includes not setting, as searching targets, the satellite signals of the signal types which are not captured in the searching for a predetermined period of time.

8. A satellite signal receiver comprising:
a processing unit which determines, based on transmitted signal information in which information indicating whether satellite signals are transmitted from positioning satellites is associated with signal types of the satellite signals and identification information of the positioning satellites, the order of searching the satellite signals.
